(19) United States
(12) Patent Application Publication
(10) Pub. No.: US 2023/0294166 A1
(43) Pub. Date: Sep. 21, 2023

(54) CORE LOCATING AND STABILIZING PIN POSITIONING TOOL AND METHOD

(71) Applicant: HONEYWELL INTERNATIONAL INC., Charlotte, NC (US)

(72) Inventors: Michael Baldwin, Phoenix, AZ (US); Aaron Moreth, Phoenix, AZ (US); Spencer T. Sotelo, Phoenix, AZ (US)

(73) Assignee: HONEYWELL INTERNATIONAL INC., Charlotte, NC (US)

(21) Appl. No.: 17/655,317

(22) Filed: Mar. 17, 2022

(51) Int. Cl. B22C 21/14; B22C 9/10

(52) U.S. Cl. CPC B22C 21/14; B22C 9/108; B33Y 80/00

(57) ABSTRACT

A tool is provided for positioning a core stabilizing pin into a preassigned hole of a plurality of holes formed in an additively manufactured mold. The tool has a main body, a pin cavity, and a standoff. When the tool is used to insert a core stabilizing pin, of a precise, controlled length, into a preassigned hole, and the core stabilizing pin is inserted until the mold engagement end contacts the outer surface of the mold, the angle of the preassigned hole and thickness of the mold precisely positions the core stabilizing pin to engage and stabilize the core.

### TECHNICAL FIELD

The present invention generally relates to additively manufactured molds with cores that are integral to the mold and have unsupported geometry, and more particularly relates to a tool and method that can be used to precisely position core locating and stabilizing pins into such molds.

### BACKGROUND

Various components are manufactured via a casting process using a mold. In some instances, the molds that are used are additively manufactured and include ceramic cores that are integral to the mold and have unsupported geometry. Controlling the positioning of these cores can be quite challenging. Indeed, correct core positioning is critical to produce conforming castings. All cores in investment casting use print-outs to position and stabilize cores as design intended within investment mold. This technique, while suitable for global core positioning may not fully constrain or position all surfaces and features of the core.

Hence, there is a need for a device and method that can precisely stabilize the core in an additively manufactured mold in which an internal core is formed. The present invention addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a tool is provided for positioning a core stabilizing pin into a preassigned hole of a plurality of holes formed in an additively manufactured mold. The mold has an outer surface and an inner surface, where the inner surface defines a cavity in which an internal core is formed. Each of the plurality of holes extends between the outer surface and the inner surface, and each hole is disposed at an angle and is further disposed at a position at which the mold has a thickness and at which the inner surface is uniquely spaced from the core. The tool has a main body, a pin cavity, and a standoff. The main body has a main body first end and a main body second end. The pin cavity is formed in the main body second end is dimensioned to receive a core stabilizing pin therein. The standoff extends from the main body second end to a mold engagement end. The mold engagement end is a predetermined distance from the main body second end, and the predetermined distance is unique to the preassigned hole. The mold has a thickness at the position of each hole, and when the tool is used to insert the core stabilizing pin, of a precise, controlled length, into the preassigned hole, and the core stabilizing pin is inserted until the mold engagement end contacts the outer surface of the mold, the angle of the preassigned hole and thickness of the mold precisely positions the core stabilizing pin to engage and stabilize the core.

In another embodiment, a kit of tools is provided for positioning core stabilizing pins into preassigned holes formed in an additively manufactured mold that has an outer surface and an inner surface, where the inner surface defines a cavity in which an internal core is formed. Each preassigned hole extends between the outer surface and the inner surface, and each preassigned hole is disposed at an angle and is further disposed at a position at which the mold has a thickness and at which the inner surface is uniquely spaced from the core. Each tool in the kit is associated with a different one of the preassigned holes, and each tool in the kit includes a main body, a pin cavity, and a standoff. The main body has a main body first end and a main body second end. The pin cavity is formed in the main body second end and is dimensioned to receive a core stabilizing pin therein. The standoff extends from the main body second end to a mold engagement end. The mold engagement end is a predetermined distance from the main body second end, and the predetermined distance is unique to its associated preassigned hole. The mold has a thickness at the position of each preassigned hole, and when each tool is used to insert a core stabilizing pin, of a precise, controlled length, into its associated preassigned hole, and the core stabilizing pin is inserted until the mold engagement end contacts the outer surface of the mold, the angle of the hole and thickness of the mold precisely positions the core stabilizing pin to engage and stabilize the core.

In yet another embodiment, a method for positioning a core stabilizing pin into a preassigned hole of a plurality of holes formed in an additively manufactured mold, wherein the mold has an outer surface and an inner surface, wherein the inner surface defines a cavity in which an internal core is formed, wherein each of the plurality of holes extends between the outer surface and the inner surface, wherein each hole of the plurality of holes is disposed at an angle and is further disposed at a position at which the mold has a thickness and at which the inner surface is uniquely spaced from the core, includes the steps of: selecting, from a kit of tools, a tool that is uniquely associated with the preassigned hole, the selected tool comprising: (i) a main body having a main body first end and a main body second end, (ii) a pin cavity formed in the main body second end, the pin cavity dimensioned to receive a core stabilizing pin therein, and (iii) a standoff extending from the main body second end to a mold engagement end, the mold engagement end being a predetermined distance from the main body second end, and the predetermined distance being unique to its associated preassigned hole; inserting a core stabilizing pin, of a precise, controlled length, into the pin cavity; and using the selected tool to insert the core stabilizing pin into the preassigned hole until the mold engagement end contacts the outer surface of the mold.

Furthermore, other desirable features and characteristics of the tool, the kit of tools, and the method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a simplified plan view of one embodiment of an additively manufactured mold;

FIG. 2 depicts a cross section view of a portion of the mold depicted in FIG. 1, and taken along line 2-2 in FIG. 1;

FIG. 3 depicts a kit of tools that may be used to insert core stabilizing pins into holes formed in the mold of FIG. 1;

FIGS. 4-6 depict various views of one of the tools depicted in the kit of FIG. 3;

FIG. 7 depicts the tool illustrated in FIGS. 4-6, but with a core stabilizing pin inserted therein; and

FIG. 8 depicts the same cross sectional view of FIG. 2, but further depicting one of the tools of FIG. 3 inserting a core stabilizing pin into a preassigned hole.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

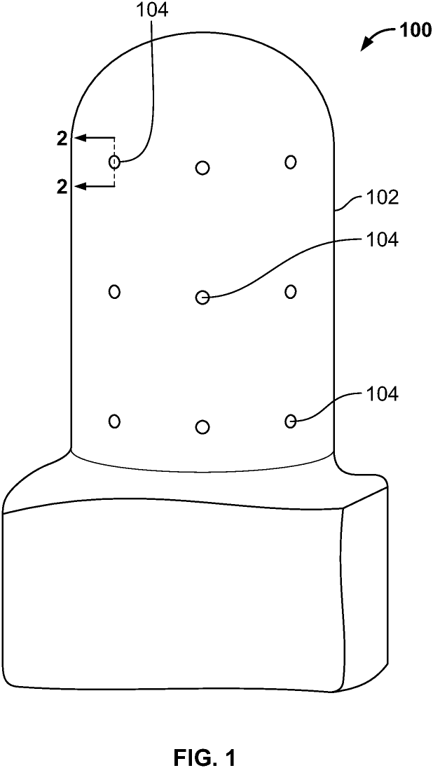

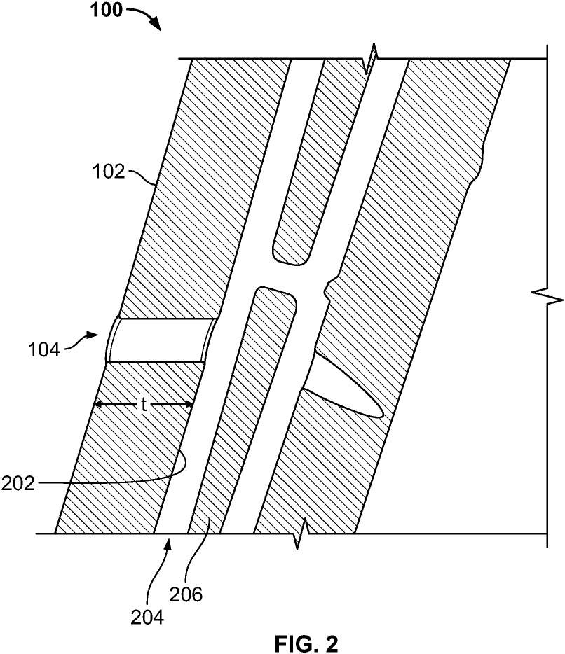

Referring to FIGS. 1 and 2, one example embodiment of an additively manufactured mold 100 is depicted. The mold 100 includes an outer surface 102 and, as shown more clearly in FIG. 2, an inner surface 202. As FIG. 2 also depicts, the inner surface 202 defines a cavity 204 in which an internal core 206 is formed. The mold 100 also has a plurality of holes 104 formed therein. In the depicted embodiment, only nine holes 104 are visible. It will be appreciated, however, that the mold 100 may be manufactured to include more or less than this number of holes 104.

No matter the number of holes 104 that are formed in the mold 100, each of the holes 104, as shown in FIG. 2, extends between the outer surface 102 and the inner surface 202. Moreover, each hole 104 is disposed at an angle. Each hole 104 is additionally disposed at a position at which (1) the mold 100 has a thickness (t) and (2) at which the inner surface 202 is uniquely spaced from the core 206. Thus, each hole 104 may also be referred to herein as a “preassigned hole.”

The mold 100 is additively manufactured and, in many cases, may be a ceramic mold. Regardless, it is additively manufactured in a manner that the core 206 is what is referred to in the art as integral to the mold and having unsupported geometry. Thus, before using the mold 100 to cast a component, the core 206 needs to be stabilized. To do so, a tool is manufactured to position core stabilizing pins into the holes 104. More specifically, a tool is manufactured for each of the preassigned holes 104 that are formed in the mold 100. Thus, a kit of tools for positioning core stabilizing pins into the preassigned holes 104 is manufactured. For the mold 100 depicted in FIG. 1, this would mean that a kit of at least nine different tools would be manufactured.

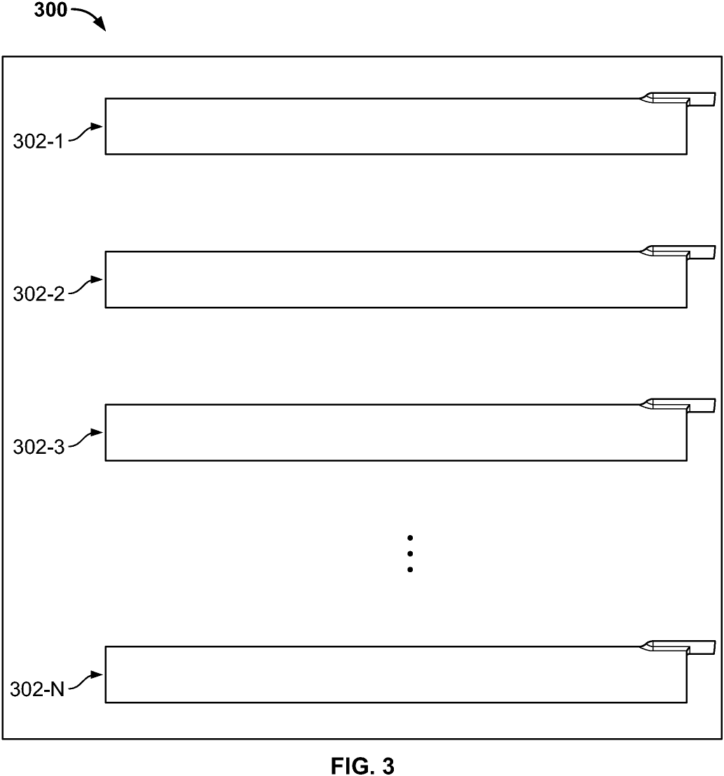

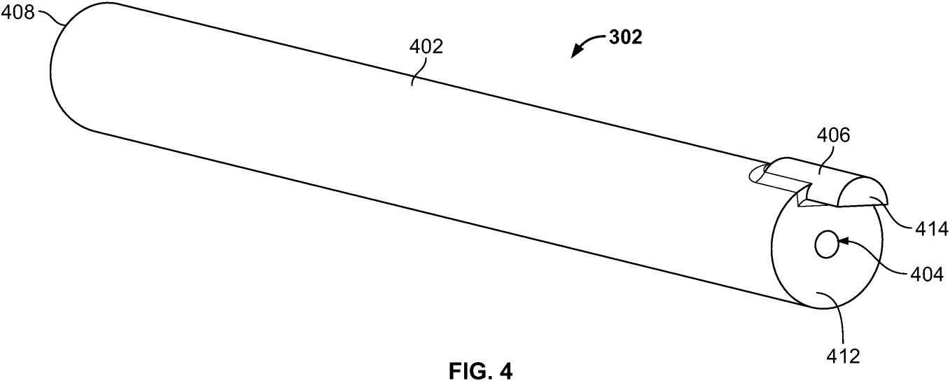

One embodiment of a specific kit of tools 300 is depicted in FIG. 3. Each kit 300 is unique to a specific mold 100 and, as just mentioned, each tool 302 (302-1, 302-2, 302-3, . . . 302-N) in the kit of tools 300 is associated with a different one of the preassigned holes 104 that are formed in the mold 100. While each tool 302 in the kit is thus unique, each tool does share some common features. With reference to FIGS. 4-6, one embodiment of a tool 302 is depicted and the features that are common to each tool 302 will now be described.

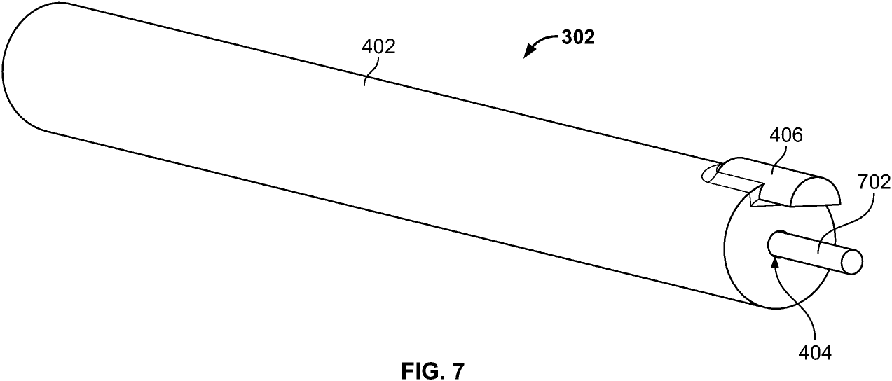

Each tool 302 includes a main body 402, a pin cavity 404, and a standoff 406. The main body 402 has a main body first end 408 and a main body second end 412. The pin cavity 404 is formed in the main body second end 412 and is dimensioned to receive a core stabilizing pin therein. With quick reference to FIG. 7, the tool 302 is depicted with a core stabilizing pin 702 disposed within the pin cavity 404. Although the core stabilizing pin 702 may be formed of various metallic and non-metallic materials, in the depicted embodiment it is formed of platinum (Pt).

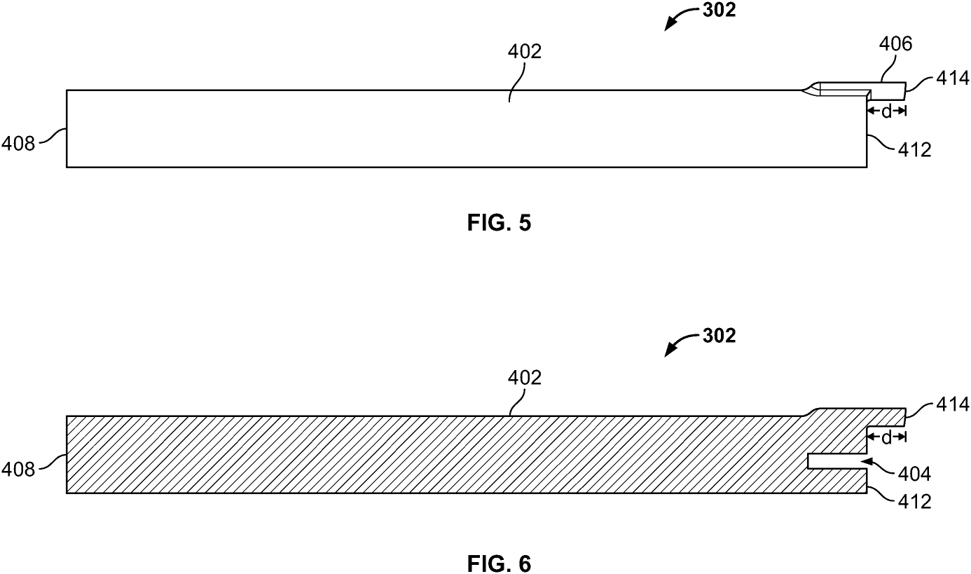

Returning to FIGS. 4-6, the standoff 406 extends from the main body second end 412 to a mold engagement end 414. The mold engagement end 414 is at a predetermined distance (d) from the main body second end 412 (see FIGS. 5 and 6). The predetermined distance (d) is unique to each tool 302 in the kit of tools 300. In particular, the predetermined distance (d) is unique to the tool’s 302 associated preassigned hole 104.

Before proceeding further, it is noted that each tool 302 is preferably, though not necessarily, manufactured using an additive manufacturing process. It will be appreciated that when an additive manufacturing process is used, various types of additive manufacturing processes may be employed. In one particular embodiment, however, the additive manufacturing process is an ultraviolet (UV) material PolyJet additive printing process. As such, the tools 300 may be precisely manufactured because 28-micron layers may be used in the UV material PolyJet additive printing process.

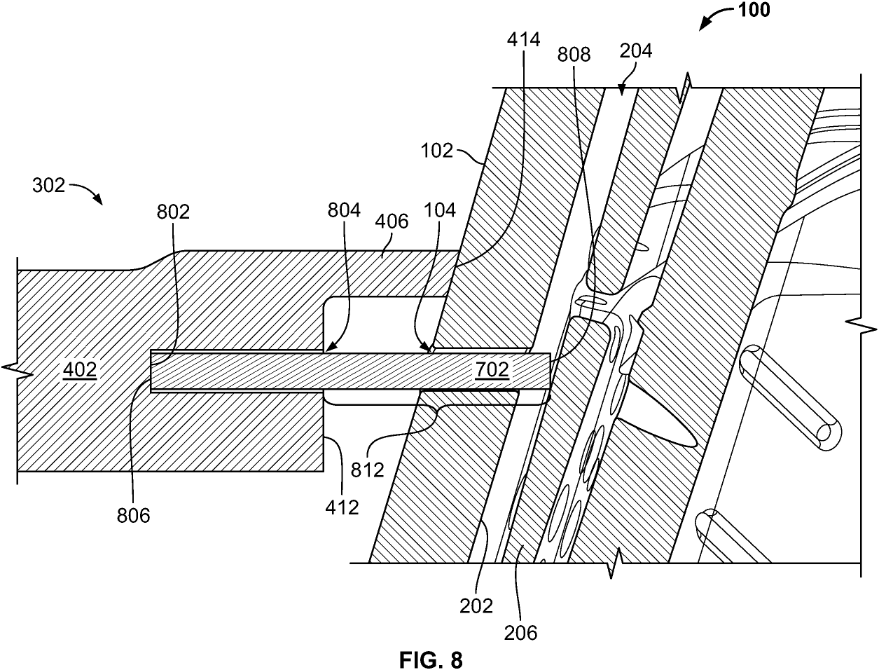

As noted above, the predetermined distance (d) that mold engagement end 414 is at, relative to the main body second end 412, is unique to each tool 302 in the kit of tools 300, and is more precisely unique to each tool’s 302 associated preassigned hole 104. Thus, and as FIG. 8 depicts, when each tool 302 is used to insert a core stabilizing pin 702 into its associated preassigned hole 104, and the core stabilizing pin 702 is inserted until the mold engagement end 414 contacts the outer surface 102 of the mold 100, the angle of the hole 104 and thickness (t) of the mold 100 precisely positions the core stabilizing pin 702 to engage and stabilize the core 206.

Having described the structure and overall function of the tools 302, a method for using a tool 302 to position a core stabilizing pin 702 into a preassigned hole 104 formed in an additively manufactured mold 100 will now be described. The method begins by selecting from the kit of tools 300, a tool 302 that is uniquely associated with the preassigned hole 104, and inserting a core stabilizing pin 702, of a precise, controlled length, into the pin cavity 404. In this regard, and with reference once again to FIG. 8, it is noted that the pin cavity 404 is defined by a closed end surface 802 and an open end 804, and that the core stabilizing pin 702 has a first end and 806 a second end 808. Preferably, the core stabilizing pin 702 is inserted into the pin cavity 404 until the first end 806 contacts the closed end surface 802. When this is done, a free section 812 of the core stabilizing pin 702 extends from pin cavity 404.

After the core stabilizing pin 702 has been properly inserted into the pin cavity 404, the selected tool 302 may then be used to insert the core stabilizing pin 702 into the preassigned hole 104 until the mold engagement end 414 contacts the outer surface 102 of the mold 100. It should be noted that in most embodiments, at least a portion of the free section 812 of the core stabilizing pin is dipped into a molten material, such as molten wax, prior to inserting the core stabilizing pin 702 into the preassigned hole 104. The tool 302 may then be separated from the core stabilizing pin 702 after the molten material has solidified.

The tool(s) and method described herein can be used to precisely stabilize the core in an additively manufactured mold in which an internal core is formed.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A tool for positioning a core stabilizing pin into a preassigned hole of a plurality of holes formed in an additively manufactured mold, the mold having an outer surface and an inner surface, the inner surface defining a cavity in which an internal core is formed, each of the plurality of holes extending between the outer surface and the inner surface, and each hole disposed at an angle and further disposed at a position at which the mold has a thickness and at which the inner surface is uniquely spaced from the core, the tool comprising:
a main body having a main body first end and a main body second end;
a pin cavity formed in the main body second end, the pin cavity dimensioned to receive a core stabilizing pin therein; and
a standoff extending from the main body second end to a mold engagement end, the mold engagement end being a predetermined distance from the main body second end, and the predetermined distance being unique to the preassigned hole, wherein:
the mold has a thickness at the position of each hole;
when the tool is used to insert the core stabilizing pin, of a precise, controlled length, into the preassigned hole, and the core stabilizing pin is inserted until the mold engagement end contacts the outer surface of the mold, the angle of the preassigned hole and thickness of the mold precisely positions the core stabilizing pin to engage and stabilize the core.

2. The tool of claim 1, wherein the tool is manufactured using an additive manufacturing process.

3. The tool of claim 2, wherein the additive manufacturing process is an ultraviolet (UV) material PolyJet additive printing process.

4. The tool of claim 3, wherein 28-micron layers are used in the UV material PolyJet additive printing process.

5. The tool of claim 1, wherein:
the tool is one of a plurality of tools associated with the mold; and
each of the plurality tools dimensioned for a different one of the plurality of holes.

6. A kit of tools for positioning core stabilizing pins into preassigned holes formed in an additively manufactured mold that has an outer surface and an inner surface, the inner surface defining a cavity in which an internal core is formed, each preassigned hole extending between the outer surface and the inner surface, and each preassigned hole disposed at an angle and further disposed at a position at which the mold has a thickness and at which the inner surface is uniquely spaced from the core, each tool in the kit is associated with a different one of the preassigned holes, and each tool in the kit comprises:
a main body having a main body first end and a main body second end;
a pin cavity formed in the main body second end, the pin cavity dimensioned to receive a core stabilizing pin therein; and
a standoff extending from the main body second end to a mold engagement end, the mold engagement end being a predetermined distance from the main body second end, and the predetermined distance being unique to its associated preassigned hole, wherein:
the mold has a thickness at the position of each preassigned hole;
when each tool is used to insert a core stabilizing pin, of a precise, controlled length, into its associated preassigned hole, and the core stabilizing pin is inserted until the mold engagement end contacts the outer surface of the mold, the angle of the hole and thickness of the mold precisely positions the core stabilizing pin to engage and stabilize the core.

7. The kit of claim 6, wherein each tool is manufactured using an additive manufacturing process.

8. The kit of claim 7, wherein the additive manufacturing process is an ultraviolet (UV) material PolyJet additive printing process.

9. The kit of claim 8, wherein 28-micron layers are used in the UV material PolyJet additive printing process.

10. A method for positioning a core stabilizing pin into a preassigned hole of a plurality of holes formed in an additively manufactured mold, wherein the mold has an outer surface and an inner surface, wherein the inner surface defines a cavity in which an internal core is formed, wherein each of the plurality of holes extends between the outer surface and the inner surface, wherein each hole of the plurality of holes is disposed at an angle and is further disposed at a position at which the mold has a thickness and at which the inner surface is uniquely spaced from the core, the method comprising the steps of:
selecting, from a kit of tools, a tool that is uniquely associated with the preassigned hole, the selected tool comprising: (i) a main body having a main body first end and a main body second end, (ii) a pin cavity formed in the main body second end, the pin cavity dimensioned to receive a core stabilizing pin therein, and (iii) a standoff extending from the main body second end to a mold engagement end, the mold engagement end being a predetermined distance from the main body second end, and the predetermined distance being unique to its associated preassigned hole;
inserting a core stabilizing pin, of a precise, controlled length, into the pin cavity; and
using the selected tool to insert the core stabilizing pin into the preassigned hole until the mold engagement end contacts the outer surface of the mold.

11. The method of claim 10, wherein:
the pin cavity is defined by a closed end surface and an open end;
the core stabilizing pin has a first end and a second end; and
the step of inserting the core stabilizing pin into the pin cavity comprises inserting the core stabilizing pin until the first end contacts the closed end surface, whereby a free section of the core stabilizing pin extends from pin cavity.

12. The method of claim 11, further comprising:
dipping at least a portion of the free section into a molten material prior to inserting the core stabilizing pin into the preassigned hole.

13. The method of claim 12, wherein the molten material is molten wax.

14. The method of claim 12, further comprising:
separating the selected tool from the core stabilizing pin after the molten material has solidified.
